(19) United States
(12) Patent Application Publication
(10) Pub. No.: US 2006/0259345 A1
(43) Pub. Date: Nov. 16, 2006

(54) User input interpreter and a method of interpreting user input

(75) Inventor: Jiri Stetina, Bracknell (GB)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/558,871

(22) PCT Filed: Jun. 3, 2004
(86) PCT No.: PCT/GB04/02369

§ 371 Date: Dec. 1, 2005

(30) Foreign Application Priority Data
Jun. 3, 2003 (GB) 0312729.7

(51) Int. Cl. G06F 17/30; G06Q 99/00; G07G 1/00

(52) U.S. Cl. 705/10; 705/1

(57) ABSTRACT

A user input interpreter (2) for interpreting user input to enable a user to provide a data processor (3) with a user command for controlling an operation to be carried out on an object presented to the user by a user interface of the data processor has: a data model provider (14) providing a data model (17) having object and operation data entry locations required to be populated in accordance with user input data to enable a user command to be generated for causing the data processor to carry out an operation on an object, each data entry location being associated with semantic identifier specifying means specifying a semantic identifier required to be associated with received user input data for that data entry location to be populated; a semantic meaning determiner (81, 82) for associating received user input data with semantic identifiers in accordance with semantic rules stored in the semantic rules store (11) to provide semantically identified user input data; and a data model populater (9) for populating data entry locations of the data model in accordance with semantically identified user input data associated with the semantic identifiers specified for those data entry locations. The data model has a data model extension (18) identifying at least one process that has to be carried out by the data processor to identify an object specified by the user. The data model populater (9) is arranged to communicate with the data processor (3) to instruct the data processor to carry out a process identified by the data model extension (18) and to return object identifier data to enable the data model populater (9) to complete an instantiation of the data model to generate the user command.

This invention relates to a user input interpreter and a method of interpreting user input to enable the user to control operation of a data processor such as, for example, a word processor, an image processor, a command processor (for controlling operation of a computer controlled machine or tool) or other data processor that may be implemented by programming computer apparatus with a software application.

In order to control an operation of such a data processor, a user must provide user input in a form that can be understood or interpreted by the data processor. This requires that the user be familiar with the specific form of user input specified by the data processor. This can be frustrating to a user and can make a data processor difficult to use until the user has familiarized him or herself with the particular form of user input that will be accepted by the data processor. In addition, different data processors may require different forms of user input which means that a user must familiarize him or herself with different forms of user input for different data processors.

In order to provide a user with at least a degree of flexibility in the manner in which they can supply user input to a data processor, semantic interpreters have been developed that provide a semantic representation and use a set of semantic interpretation rules to interpret a user's input so that different forms of user input having the same semantic meaning are identified by the semantic interpreter as representing the same input command.

Generally, the semantic representation is provided by a data model that defines the required semantic data and provides semantic data entry locations or “data slots” to be filled by the semantic interpreter as a result of processing user input in accordance with the semantic interpretation rules. The semantic interpreter must, however, have access to and utilize the data processor because only the data processor has access to the data being processed by the data processor, for example in the case of a data processor having a graphical user interface (GUI), only the data processor has access to data defining the identification and location of individual objects displayed to the user by the graphical user interface.

In one aspect, the present invention provides a user input interpreter for interpreting user input to enable a user to control an operation of a data processor, the user input interpreter having a data model provider configured to provide a data model that defines a semantic representation of the semantic data required by the data processor to enable the user to control an operation of the data processor and a semantic interpreter for interpreting user input in accordance with a set of interpretation rules to populate to data model with the required semantic data, wherein the data model provider is also configured to provide data model extension data that associates at least some of the required semantic data with data processor access data required to cause the data processor to process that semantic data.

In an embodiment, the present invention provides a user input interpreter for interpreting user input to enable a user to provide a data processor with a user command for controlling an operation to be carried out on an object presented to the user by a user interface of the data processor, the user input interpreter comprising:
user input data receiving means for receiving user input data specifying an object presented to the user by the user interface and the operation to be carried out on the object;
semantic rule accessing means for accessing a semantic rules store storing semantic rules associating different possible user input data with semantic identifiers identifying the semantic data type of that possible user input data;
data model providing means providing a data model having object and operation data entry locations required to be populated in accordance with user input data to enable a user command to be generated for causing the data processor to carry out an operation on an object, each data entry location being associated with semantic identifier specifying means specifying a semantic identifier required to be associated with received user input data for that data entry location to be populated;
semantic meaning associating means for associating received user input data with semantic identifiers in accordance with the semantic rules stored in the semantic rules store to provide semantically identified user input data; and
data model populating means for populating data entry locations of the data model in accordance with semantically identified user input data associated with the semantic identifiers specified for those data entry locations,
the data model having data model extension data providing means providing extension data identifying at least one process that has to be carried out by the data processor to identify an object specified by the user,
the data model populating means being arranged to communicate with the data processor to instruct the data processor to carry out a process identified by the extension data and to return object identifier data that identifies to the data processor the object specified by the user and the data model populating means being arranged to complete population of the data model to generate the user command upon receipt of the object identifier data.

In a user input interpreter embodying the present invention, access to the data processor is thus defined by the data model extension data. The access data required for a particular user input by a particular data processor need not be provided as part of the user input interpreter but may be provided by, for example, the designer of the user interface for that particular data processor. Thus, a single or generic user input interpreter can be provided that can be tailored to the requirements of a specific data processor by the designer of the user interface for that data processor. Moreover because the data processor is accessed or called from the extension data within the data model the user input interpreter has access to the context of the entire data model when accessing the data processor.

Embodiments of the present invention will now be described, by way of example, with reference to the accompanying drawings, in which:

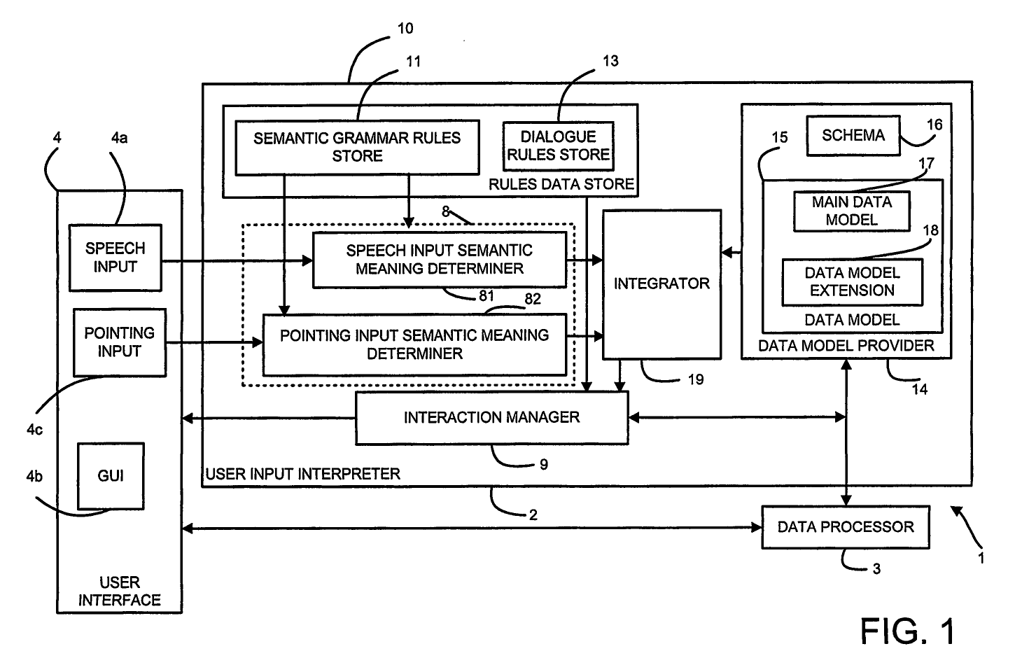

FIG. 1 shows a functional block diagram of data processing apparatus having a user input interpreter embodying the present invention;

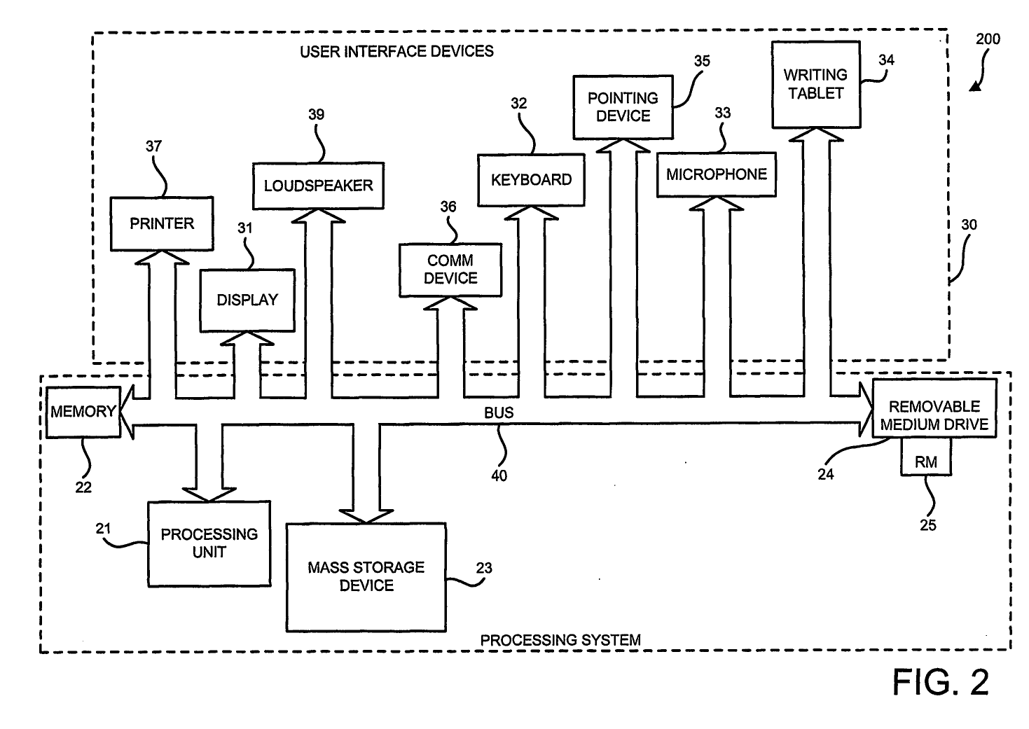

FIG. 2 shows a block diagram of computing apparatus that may be programmed to provide the data processing apparatus shown in FIG. 1;

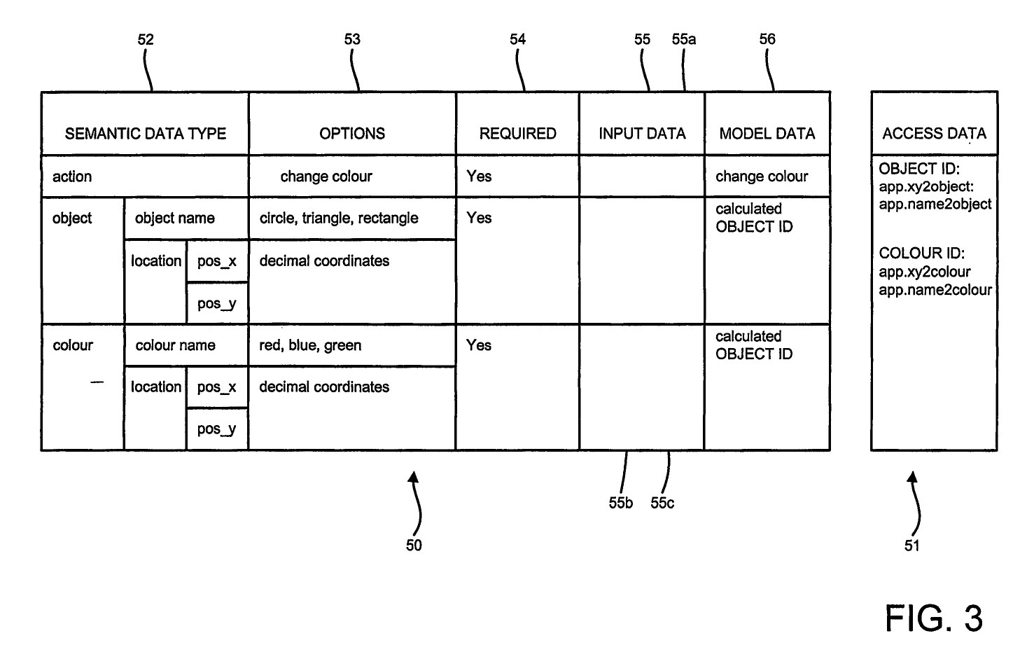

FIG. 3 shows a diagram for explaining the structure of a data model provided by a data model provider of the user input interpreter;

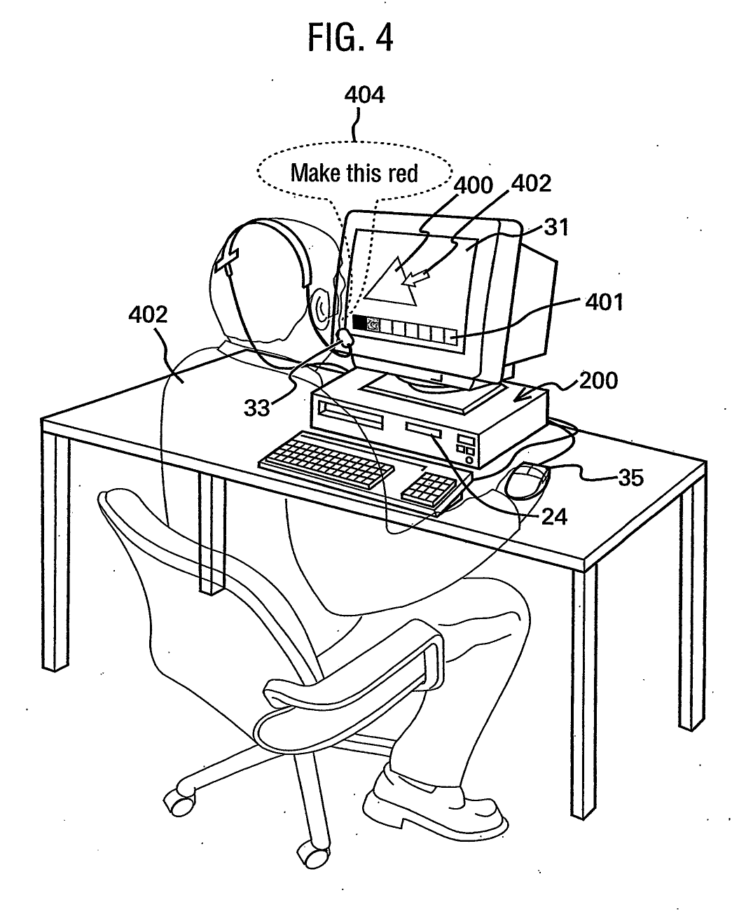

FIG. 4 shows a diagrammatic perspective view of a user using data processing apparatus embodying the present invention;

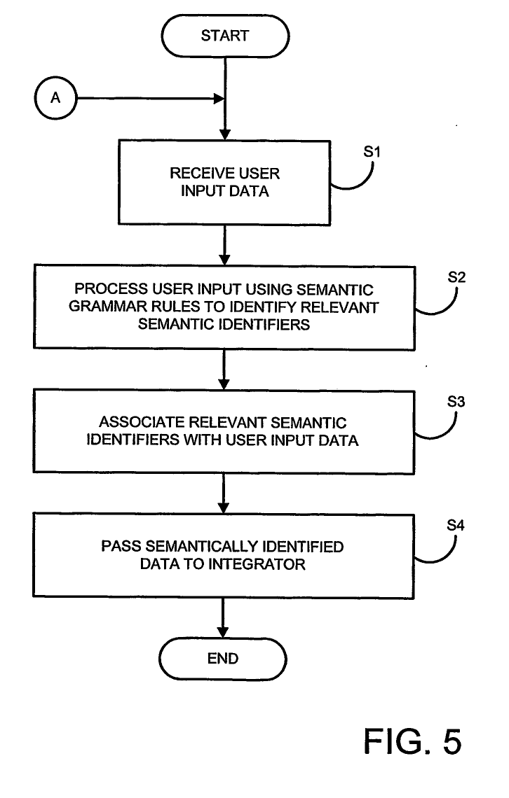

FIG. 5 shows a flow chart for explaining operation of a semantic meaning determiner of the user interpreter shown in FIG. 1;

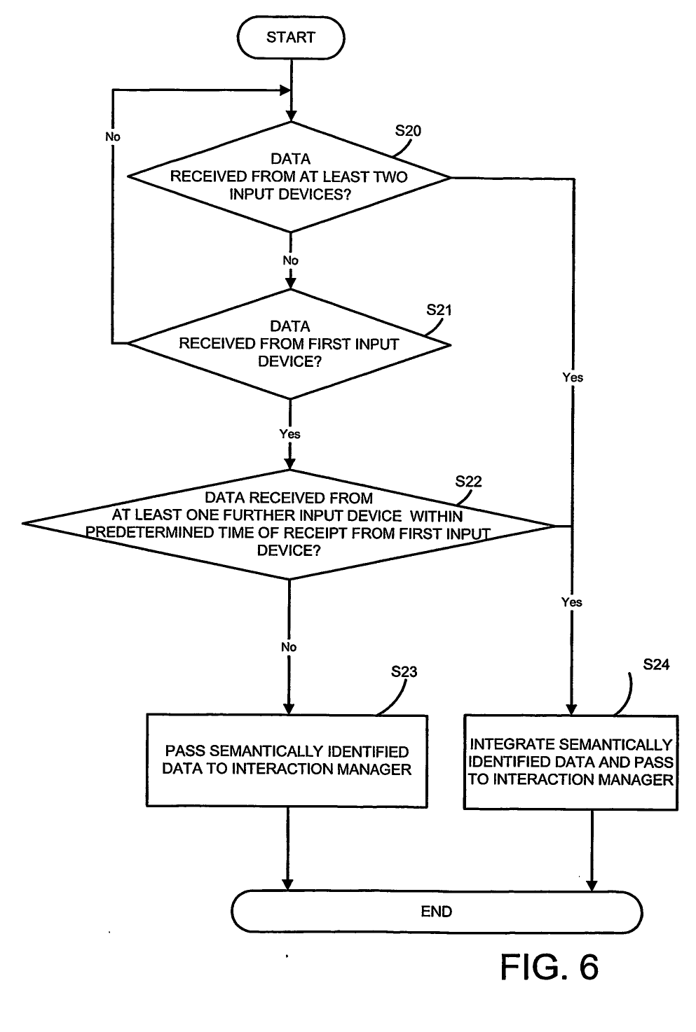

FIG. 6 shows a flow chart for explaining operation of an integrator shown in FIG. 1; and

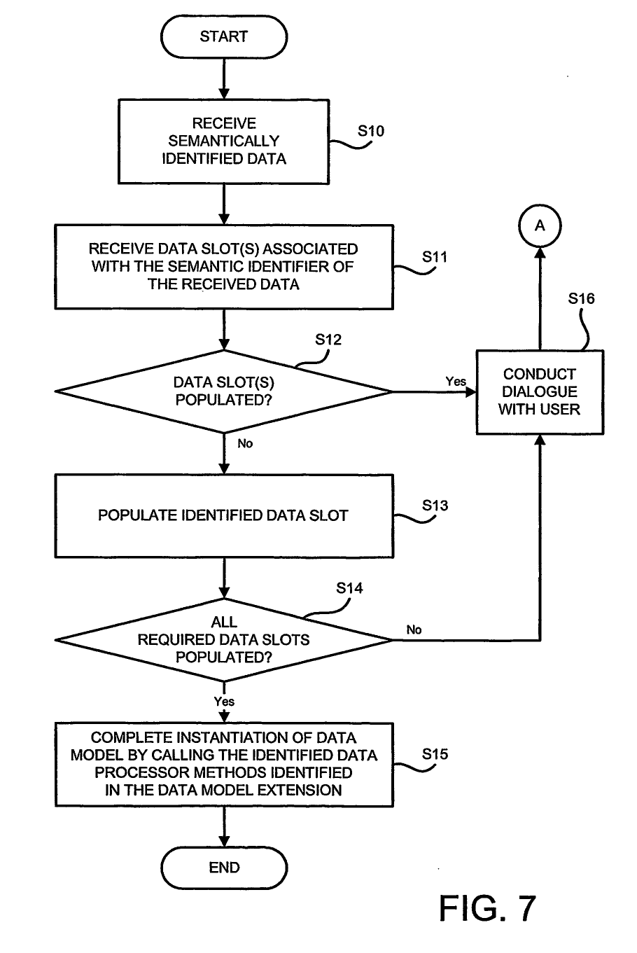

FIG. 7 shows a flow chart for explaining operation of an interaction manager shown in FIG. 1.

Referring now to the drawings, FIG. 1 shows a functional block diagram of a data processing apparatus 1 having a user input interpreter 2 embodying the present invention.

The data processing apparatus 1 comprises a data processor 3 configured to control processing of data. The data processor may be for example, a word processor, an image processor, a user input data processor for controlling operation of a machine or tool in accordance with user input or any other form of data processor that can be implemented by programming computer apparatus.

The data processor 3 is coupled to a user interface 4 via which the data processor 3 provides a graphical use interface (GUI) 4b for displaying information to the user.

The user interface 4 is also coupled to the data processor 3 via a user input interpreter 2. The user input interpreter 2 is configured to interpret user input so that different forms of user input having the same semantic meaning are interpreted by the user input interpreter 2 to represent the same user input command.

In this example, the user interface 4 has a speech user input 4a for enabling a user to provide user input in the form of speech, for example using a microphone and speech recognition software, and a pointing input 4c for enabling a user to point at and select objects on the graphical user interface 4b using, for example, a mouse or other pointing device.

The user input interpreter 2 comprises a semantic meaning determiner section 8 that provides a respective semantic meaning determiner for each different type of the user input. Thus, in this example, the semantic meaning determiner section 8 has a speech input semantic meaning determiner 81 and a pointing input semantic meaning determiner 82.

The semantic meaning determiners 81 and 82 are coupled to a rules data store 10 having a semantic grammar rules store 12 that stores semantic grammar rules. The semantic meaning determiners 81 and 82 are configured to parse user input using the semantic grammar rules to identify the semantic meaning of received user input data and to associate received user input data with semantic identifiers (“semantic tags”) identifying the determined semantic meaning to provide semantically identified (“semantically tagged”) data.

The semantic meaning determiners 81 and 82 are coupled to provide the semantically identified or tagged data 2 to an integrator 19 which is arranged to integrate the semantically identified data from the semantic meaning determiners (in the process effecting disambiguation, if necessary as will be described below) and to supply the integrated semantically identified data to an interaction manager 9.

The interaction manager 9 is also coupled to a dialog rules store 13 of the rules data store 10. The dialog rules store 13 stores dialog rules for enabling the interaction manager 9 to conduct a dialog with the user via the user interface 4.

The user input interpreter 2 also has a data model provider 14 that stores a data model 15 comprising a main data model 17 that defines a semantic representation for a corresponding user input command and provides data entry locations or slots to be populated by the interaction manager 9. Each data entry location or slot is associated with a specific different semantic tag or identifier that defines the type of semantic data with which that data entry location can be populated.

In addition to the main data model 17, the data model 15 includes a data model extension 18 that provides access data for accessing or calling a procedure or method of the data processor 3 necessary to identify an object or location on the graphical user interface 4b.

The data model provider 14 also stores a schema 16 that defines the overall rules of and constraints on the data model.

The interaction manager 9 communicates with the data processor 3 and the data model provider 14 to enable the data slots or data entry locations of the data model to be populated by the data provided by the integrator 9.

The inclusion of the data model extension 18 enables the data model to be populated under the control of the interaction manager 9 without the interaction manager 9 having to access the data processor 3 until the data model has been fully populated, that is until all of the data entry locations in the data model required to be filled have been filled.

Once all of the data entry locations of the data model has been populated with data of the required semantic type, the interaction manager 9 causes procedures or methods of the data processor 3 defined by the access data in the data model extension 18 to be accessed or called to enable the interaction manager 9 to instantiate the data model. The user input interpreter 2 thus has access to the context of the entire data model when accessing the data processor 3.

As described above, access to the data processor 3 is defined by the data model extension data. The access data required for a data model for a particular semantic representation and for a particular data processor need not be provided as part of the user input interpreter but may be provided by, for example, the designer of the user interface for that particular data processor. Thus, a generic user input interpreter can be provided that can be tailored to the requirements of a specific data processor by the designer of the user interface for that data processor.

FIG. 2 shows a block diagram of computing apparatus 200 that may be programmed by processor-implementable instructions to provide the data processing apparatus 1 shown in FIG. 1.

The computing apparatus 200 comprises a processing system 20 having a processing unit 21 coupled by a bus 40 to a memory 22 in the form of ROM and/or RAM, a mass storage device 23 such as a hard disk drive and a removable medium drive 24 for receiving a removable medium such as, for example, a floppy disk, CD ROM, DVD or the like.

The bus 40 is also coupled to a number of user interface devices 30 that are configured to provide the user interface 4 shown in FIG. 1. In this example, the user interface devices include a display 31, a keyboard 32, a microphone 33, a writing tablet 34, a pointing device 35, a printer 37 and a loudspeaker 39. The user interface devices also include a communications device 36 (COMM device) such as a MODEM and/or network card that enables the computing apparatus 200 to communicate with other computing apparatus either directly or over a network such as a local area network, wide area network, intranet or the Internet.

The computing apparatus 200 is programmed to provide the data processing apparatus shown in FIG. 1 by processor implementable instructions and data provided by at least one of:

pre-installation in the memory 22 or on the mass storage device 23;

downloading from a removable medium 25 received by the removable medium drive 24;

input by a user using one or more of the user input devices such as the keyboard 32;

supplied as a signal from another computing apparatus via the communications device 36.

Operation of the user input interpreter 2 will now be described in greater detail with the help of FIGS. 3 to 7 in which FIG. 3 shows a diagram for assisting in explaining the structure of a data model 15 stored by the data model provider 14, FIG. 4 shows a perspective view of a user using data processing apparatus embodying the invention and FIGS. 5 to 7 show flow charts for illustrating operation of the user input interpreter 2.

Referring firstly to FIG. 3, this shows a first table 50 representing the data structure and content of the main data model 17 and a second table 51 representing the structure and content of the data model extension 18.

The table 50 has columns 52 to 56 headed “semantic data type”, “options”, “required”, “received user input data” and “model data”, respectively. The column headed “semantic data type” represents the part of the main data model 17 that defines the types of semantic data relevant to the particular semantic representation while the column 53 headed “options” represents the part of the main data model 17 defining the available options for each semantic data type and the column 54 headed “required” represents the part of the main data model 17 that defines whether or not user input for a particular semantic data type is required to populate the data model fully. Column 55 represents the data entry locations or data slots of the data model 15, that is the part of the data model that is populated in accordance with user input, while column 56 represents the final model data that is the model data that is after the data model has been instantiated after methods or procedures of the data processor 3 have been called using the access data to return to the interaction manger 9 the actual object and colour on the graphical user interface 4b to which the user's input refers.

The constraints on the semantic data defined by the options column 53 and the required column 54 shown in FIG. 3 are constraints imposed by the data model schema 16.

The second table 51 shown in FIG. 3 stores the access data provided by the data model extension.

FIG. 3 illustrates an example where the data model 15 relates to a user action to change the colour of an object displayed by the graphical user interface (GUI) 4b of the data processor 3. In this case, the semantic data types shown in column 50 include an “action” semantic data type”, an “object” semantic data type” and a “colour” semantic data type”, all of which are required, as specified in column 54, to populate the data model. In this example, the data entry location 55a can be omitted or pre-filled because there is only one available option for the semantic data type “action”, namely a command from the user to change colour while the data entry location 55b requires data determined by one of the semantic meaning determiners as being of the semantic data type “object” and the data entry location 55c requires data determined by one of the semantic meaning determiners as being of semantic data type “colour”.

In this example, the user has available speech and pointing inputs 4a and 4c and can specify an object displayed on the graphical user interface 4b by spoken input identifying the name of the object or by pointing input identifying the x,y co-ordinates of the object on the graphical user interface 4b. Similarly, the user can identify the desired colour for the object either by spoken input naming the colour or by pointing input identifying the location in a colour palette of the required colour. Accordingly, the data model provides two alternatives for the semantic data types “object” and “colour” namely “object name” and “object location” and “colour name” and “colour location” with the “data types”, “object location” and “colour location” both requiring x and y coordinate position input data identified in FIG. 3 as “pos_x” and “pos_y”.

In this example, the data model schema 16 constrains the available object names to “circle”, “triangle” and “rectangle” and constrains the available colour names to “red”, “blue” and “green”. The data model schema also constrains the location input to be in a form of decimal coordinates as shown in column 53.

As explained above, information identifying the objects displayed on the graphical user interface and the locations of those objects in the graphical user interface 4b of the data processor 3 is available only to the data processor 3 and not to the user input interpreter 2 and to enable the interaction manager 9 to access this information to complete the instantiation of the data model in accordance with the user's input, the access data 51 of the data model extension 18 includes calls to methods or procedures that have to be carried out by the data processor 3 to identify the object and the colour on the graphical user interface 4b. As shown in FIG. 3, in this example, the data model extension 18 provides two alternative calls to identify the object and two alternative calls to identify the colour, namely:
app.xy2object
app.name2object
app.xy2colour
app.name2colour

The interaction manager 9 will use the call “app.xy2object” when the data model is populated with data identifying an object's x, y position and the call “app.name2object” when the data model is populated with data identifying an object by name. Similarly, the interaction manager 9 will use the call “app.xy2colour” when the data model is populated with data identifying an colour's x, y position and the call “app.name2colour” when the data model is populated with data identifying a colour by name.

In this particular example, the data model 15 is implemented using Xforms which is described in detail in the document entitled “Xforms-the next generation of web forms” available on line at http://www.w3.org/Markup/Forms/. XForms is a specification of web forms that can be used in a wide variety of platforms including desktop computer, hand held information appliances. In this case, the data model schema 16 is an XML schema, the main data model 17 is defined by an Xform and the data model extension 18 is defined by extending the Xforms model binding property definition which is described in the document entitled “Xforms 1.0” available for downloading from http://www.w3.org/TR/2002/CR-xforms-20021112/, in particular section 7.4 of that document, to allow application methods within the calculate property of the Xforms model item.

The Xforms main data model 17 for the data model example illustrated by FIG. 3 has the following form:

```
<instance>
    <object/>
        <object_id/>
        <object_name/>
        <pos_x/>
        <pos_y/>
    </object>
    <colour>
        <colour_id/>
        <colour_name/>
        <pos_x/>
        <pos_y/>
    </colour>
</instance>
```

where the bracket structure < /> indicates a data entry location or data slot and contains data identifying the semantic tag or identifier required to be associated with data to populate that data entry location.

(No action is specified in this main data model because, as explained above with reference to FIG. 3, this particular data model provides for only one possible action, namely the action “change colour”.)

In this example, the access data provided by the data model extension 18 comprises:

```
<xforms:bind nodeset= “object_id”
    calculate=“app.xy2object(/object/pos_x,/object/
pos_y)”>
<xforms:bind nodeset= “object_id”
    calculate= “app.name2object(/object/object_name)”/>
<xforms:bind nodeset= “colour_id”
    calculate= “app.xy2colour(/colour/pos_x,
/colour/pos_y)” />
<xforms:bind nodeset= “colour_id
    calculate= “app.name2colour(/colour/name)” />
```

In this example, the semantic grammar rules in the semantic grammar rules store 11 are written using the XML XPath language which is described in a document entitled “XML Path language (XPath) version 1.0” and can be downloaded from http:/www.w3.org/TR/xpath and include:

a first semantic grammar rule:

```
public <task> = [ please ] make this
      ( blue { /colour/colour_name = “blue”; } |
        red { /colour/colour_name = “red”; } |
        green { /colour/colour_name = “green” } )
```

that associates spoken words representing the colour names “blue”, “red” and “green” with the semantic tag “colour_name”,

a second semantic grammar rule:

```
    public <task> = [ please ] make
        ( circle { /object/object_name = “circle”; }
|
        triangle { /object/object_name = “triangle”; }
|
            rectangle { /object/object_name =
“rectangle”; } )
        ( blue { /colour/colour_name = “blue”; } |
          red { /colour/colour_name = “red”; } |
          green { /colour/colour_name = “green” } )
```

that associates spoken words representing the object names “circle”, “triangle”, and “rectangle” with the semantic tag “object_name”,

a third semantic grammar rule:

public <task> = pointing { /object/pos_x = x &
/object/pos_y = y }

that associates the semantic tags pos_x and pos_y for an object with x and y coordinates from the pointing input 4c, and

a fourth semantic grammar rule:

public <task> = pointing { /colour/pos_x = x &
/colour/pos_y = y }

that associates the semantic tags pos_x and pos_y for a colour in a colour palette with x and y coordinates from the pointing input 4c.

FIG. 4 shows a diagrammatic representation of a user 402 using the data processing apparatus 1 where the user has decided to use the pointing device or mouse 35 to position a cursor 402 of the graphical user interface on a displayed triangle 400 and to say the words “make this red” as shown by the speech bubble 404 in FIG. 4 into the microphone 33. The user could, however, as other possibilities have used the pointing device 35 to point to a specific colour on a colour pallet 401 and said, for example “make the triangle this colour” or “colour the triangle with this colour”.

Operation of the user input interpreter 2 to interpret these user inputs will now be described with the aid of the flow charts shown in FIGS. 5 to 7.

FIG. 5 shows the steps carried out by each of the semantic meaning determiners 81 and 82.

Thus, when the user speaks the words “make this red”, the speech input semantic meaning determiner 81 receives speech input data from the automatic speech recogniser of the speech input 4a at S1 in FIG. 5. The speech input semantic meaning determiner 81 parses the received speech data in accordance with the semantic grammar rules stored in the semantic grammar rules store 11 to identify relevant semantic identifiers or tags at S2 in FIG. 5.

In this example, the speech input semantic meaning determiner 81 identifies the user input data representing the spoken word “red” as corresponding to the semantic grammar rule:

```
public <task> = [ please ] make this
      ( blue { /colour/colour_name = “blue”; } |
        red { /colour/colour_name = “red”; } |
        green { /colour/colour_name = “green” } )
```

The speech input semantic meaning determiner 81 therefore associates the spoken user input “red” with the semantic tag “colour_name” at S3 in FIG. 5 to provide semantically identified or tagged data. The speech input semantic meaning determiner 81 then passes the semantically identified data to the integrator 19 at S4.

Similarly, when the user uses the pointing device to point at a location on the graphical user interface 4b, the pointing input semantic meaning determiner 82 receives from the pointing input 4c x, y coordinate position input data representing the x and y location on the graphical user interface 4b at which the pointing device is pointing at S1 and then, at S2, determines which of the semantic grammar rules stored in the semantic grammar rules store 11 relate to x, y coordinate position input data to identify relevant semantic identifiers or tags at S2 in FIG. 5.

In this example, the pointing input semantic meaning determiner 81 identifies the user input data representing the x and y coordinate positions of the pointing device as corresponding to either the semantic grammar rule:

public <task> = pointing { /colour/pos_x = x &
/colour/pos_y = y }

or the semantic grammar rule:

public <task> = pointing { /object/pos_x = x &
/object/pos_y = y }

Thus, in this case, at S3 the pointing input semantic meaning determiner 82 associates the x coordinate position input data with the semantic identifier colour/pos_x and with the semantic identifier object/pos_x and associates the y coordinate position input data with the semantic identifier colour/pos_y and with the semantic identifier object/pos_y.

Then, at S4, the pointing input semantic meaning determiner 82 passes these two sets of semantically identified or tagged data to the integrator 19.

FIG. 6 shows a flow chart illustrating steps carried out by the integrator 19.

At S20, the integrator 19 checks whether at least two semantic meaning determiners have simultaneously received user input data. If the answer is no, then at S21 the integrator 19 checks to see if a first one of the semantic meaning determiners has received user input data and, if the answer is yes, waits to see if another one of the semantic meaning determiners receives user input within a predetermined time of the receipt of user input by the first semantic meaning determiner. If, at S22, a second semantic meaning determiner does not receive user input within a predetermined time of the receipt of user input by the first semantic meaning determiner data, then at S23, the integrator passes the semantically identified or tagged data received from the first semantic meaning determiner to the interaction manager 9 without further processing.

If, however, the integrator 19 determines at S20 that at least two semantic meaning determiners have simultaneously received user input data or at S22 that at least two semantic meaning determiners have received user input data within a predetermined time of one another, then at S24 the integrator integrates the semantically identified or tagged data from the semantic meaning determiners 81 and 82 and passes the integrated semantically tagged data to the interaction manager 9.

In the example described above with reference to FIG. 4, the speech input semantic meaning determiner 81 and the pointing input semantic meaning determiner 82 receive user input at the same time because the user uses the pointing device to point to the triangle while saying the words “make this red”. Thus, in this example, the answer at S20 is yes. Accordingly, the integrator 19 integrates the semantically tagged data at S24. In this example, the semantically tagged data from the pointing input semantic meaning determiner 82 represents two possible options, namely either a colour or an object position. Therefore, before integrating the semantically tagged data, the integrator 19 has to disambiguate the two options to select the correct one.

In order to identify the correct one of the two options, the integrator 19 requests the interaction manager 9 to determine from the data model 15 the types of semantic data required by the data model. In this example, the interaction manager 9 will advise the integrator 19 that there are only two required semantic data types, object and colour.

The integrator 19 also assumes that the pointing input semantic meaning determiner 82 provides data of a different semantic type from the speech input semantic meaning determiner 81 (because a user would not normally specify an object both by spoken input and pointing input, for example, a user would not normally both say “triangle” and point to the triangle in FIG. 4). Therefore in the example being described, the integrator 19 assumes, because the speech input semantic meaning determiner 81 has tagged the word “red” with the semantic tag representing the semantic data type “colour”, namely “colour-name”, that the correct semantically tagged data from the pointing input semantic meaning determiner 82 is the data tagged with semantic tags representing the semantic data type “object” (namely the semantically tagged data tagged with the semantic identifiers or tags object/pos_x object/pos_y) and not the tagged with semantic tags representing the semantic data type “colour” (that is the semantically tagged data tagged with the semantic identifiers or tags colour/pos_x colour/pos_y).

Accordingly, the integrator 19 determines that the data tagged with the semantic identifiers or tags object/pos_x object/pos_y provided by the pointing input semantic meaning determiner 82 should be integrated with the semantically tagged data from the speech input semantic meaning determiner 82 tagged with the semantic tag “colour_name”.

In the present case, the information provided by the interaction manager 9 that there were only two semantic data types required by the data model 15 and the assumption by the integrator 19 that the different semantic meaning determiners provide data tagged with different semantic tag types was sufficient to enable the integrator 19 to identify the correct set of semantically tagged data from the pointing input semantic meaning determiner 82. If, however, this information and assumption are not sufficient to enable the integrator 19 to identify the correct option, then the integrator 19 will, at S24 in FIG. 6, ask the interaction manager 9 to conduct a dialog with the user using dialog rules stored in the dialog rules store 13 to identify the correct option. For example, the interaction manager may cause the graphical user interface 4a to display a prompt to the user such as: “what are you pointing at? ” or, if the interaction manager or user interface includes text-to-speech processing ability, cause the loudspeaker 39 (FIG. 2) to issue the same message. It should be noted that, instead of conducting a dialog with the user, the correct option could be identified in other ways. For example, the correct option in many circumstances could be automatically identified (that is, without user input) using predetermined heuristics. Of course, a combination of automatic identification and user dialog could be used.

FIG. 7 shows steps carried out by the interaction manager 9.

Thus, when at S10 the interaction manager 9 receives semantically tagged data (whether integrated or not) from the integrator 19, then at S11 the interaction manager 9 identifies the data slot(s) of the main data model 17 associated with the semantic tag(s) of the semantically tagged data and at S12 checks to see if those data slot(s) is (are) already populated. If the answer is yes, then at S16 the interaction manager 9 will conduct a dialog with the user using the dialog rules in the dialog rules store 13 to prompt the user to provide further input. For example, in the example given above, if the user says “make this red” so that the colour _name data slot is then populated and then says “blue”, the interaction manager 9 may, having determined that the colour_name data slot is already populated, then issue a prompt saying “do you want the object to be red or blue?”

If, however, the answer at S12 is no, then the interaction manager 9 causes the data slot(s) to be populated at S13 and checks at S14 if all of the required data entry locations or data slots the main data model 15 have been populated. If the answer is no, the interaction manager 9 conducts a dialog with the user at S16 using the dialog rules in the dialog rules store 13 to prompt the user to provide further user input to populate the remaining data entry locations or data slots. Thus, if in example illustrated above with reference to FIG. 4, the user simply says “make this red” but does not identify an object, then the interaction manager 9 will issue a prompt such as “what object do you want to make red?”

Once the answer at S14 is yes, then at S15, the interaction manager 9 determines from the partly instantiated data model and the data model extension 18 which of the data processor 3 methods correspond to populated data entry locations or data slots. Thus, in the example given above where the object <pos_x/> and <pos_y/> data slots and the <colour_name/> data slot have been filled (because the user pointed at the object and said “make this red”), the interaction manager 9 determines that the relevant methods or procedures of the data model extension are:

calculate=“app.xy2object(/object/pos_x, /object/pos_y)” and

calculate=“app.name2colour(/colour/name)”.

The interaction manager 9 then requests the data processor 3 to execute the determined methods or procedures so that the data processor 3 returns the corresponding object and colour identifiers that otherwise would have been known only to the data processor 3. The interaction manager 9 can then complete instantiation of the data model by incorporating the colour and object identifiers provided by the data processor 3 (that is filling the model data of column 56 in FIG. 3).

In the example being described, the final instantiation of the data model may be:

```
<instance>
    <object/>
        <object_id>0016<object_id>/>
    </object>
    <colour>
    <colour_id>115<colour_id/>
    </colour>
</instance>
```

where 0016 and 115 are the returned object and colour identifiers, respectively.

The interaction manager can then cause the data processor 3 to carry out the action required by the user in accordance with the fully instantiated data model instance, causing in the example given above, the triangle to be coloured red.

The example described above is relatively simple and specific to a user input that relates solely to the action of the changing of the colour of a displayed object. An example where the data model provides a user with a number of different action options will now be described with the aid of Appendices 1 to 5 in which Appendix 1 shows the XML schema 16, Appendix 2 shows an instance of the XML schema, Appendix 3 shows the main data model 17, Appendix 4 shows the data model extension and Appendix 5 shows instances of the data model

As mentioned above the XML schema defines the rules and constraints upon the data model. The form of the XML schema shown in Appendix 1 is generally the same as that used for the simple example described above. The instance of the XML schema shown in Appendix 2 specifies constraints for various elements of the data model. Thus, as shown, the instance of the XML schema specifies, amongst other things that:

each instance must have element references for one action and one object and may have a group reference “specification” defining a choice of operations that the user can instruct be performed;

the action of a data model instance can only be any one of: move, copy, delete, resize, change colour;

the object of a data model instance can only be any one of: restricted to circle, triangle and rectangle;

the group specification provides that a data model instance must have at least one of a location, colour and scale with the scale being constrained to decimal values a data model instance can have only one set of x, y coordinates;

a data model instance can have only one colour selected from red, green and blue.

The data model shown in Appendix 3 provides two instance options:

A first instance option src “0” providing data slots or entry locations for:

an action (which is constrained by the instance of the XML schema to be one of move, copy, delete, resize or changecolour)

an object location as pos_X and pos_y or object name (shape ID)

a colour location as pos_x and pos_y or colour name (which is constrained by the instance of the XML schema shown in Appendix 2 to be red, green or blue)

a scale

and a second instance option src“1” providing data slots or entry locations for:

an action

an object name (shape ID)

a scale

The bind references in the data model shown in Appendix 3 require that any instance of the data model always have one action and one object, require a colour location or colour name if the action is “changecolour”, require a location if the action is move or copy and require a scale if the action is “resize”.

The data model extension 18 shown in Appendix 4 provides calls to data processor methods similar to those for the simple example given above.

Thus, in this example, the user can input user commands to move, copy, delete, resize, or change the colour of a circle, triangle or rectangle with, where the user elects to change colour, the available colours being selected from red, green and blue and, as in the simple example, the user input interpreter will interpret user input commands having the same semantic meaning in the same manner so that the user can elect to use either the pointing device or spoken input to identify an object, location or colour, for example.

As in the simple example, once the data entry locations or data slots required to be filled by the data model have been filled by semantically tagged user input data provided by the semantic meaning determiners 81 and 82, then the interaction manager 9 requests the data processor 3 to implement the methods specified by the data model extension 18 shown in Appendix 4 to return the object and, if required, colour identifiers to enable the interaction manager 9 to complete instantiation of the data model for the particular user input.

Appendix 5 shows examples of various instances of the data model shown in Appendix 3 with instances 0, 1, 4 and 5 being data model instances that will cause an object at a specific location to be moved to another location, instances 2, 3, 6 and 7 being data model instances that will cause a circle to be moved to another location, instances 8, 9 and 11 being data model instances that will cause an object at a specific location to be resized in accordance with a specified scale and instance 10 being a data model instance that will cause a circle to be resized in accordance with a specified scale

As described above, the pointing input semantic meaning interpreter 82 is arranged to interpret position data input from a pointing device. The pointing input semantic meaning determiner may, however, be a generic position input semantic meaning determiner arranged to determine the semantic meaning of any one or more forms of position input that select a location on the graphical user interface, for example a keyboard, graphics tablet or a touch sensitive display input alternatively or in addition to the pointing device input.

In the above embodiments, the speech input semantic meaning determiner 82 is arranged to determine the semantic meaning speech input. This semantic meaning determiner may, however, be a text semantic meaning determiner 82 arranged to determine the semantic meaning for any one or more different forms of text input, for example any one or more of speech, keyboard, handwriting input via the writing tablet, provided the user interface has an appropriate input to text data converter, that is a speech recognition engine in the case of speech input and a handwriting recognition engine in the case of handwriting input.

Also, if the computing apparatus shown in FIG. 2 is provided with a camera and the user input has appropriate recognition software, the direction of the user's gaze may be used to provide position input and movement of the user's lips may be detected to obtain viseme data that can be converted to provide text input.

The present invention may be applied when any one or more of the above-described different inputs are available. For example, the present invention may be applied when only text data input (in one of the forms mentioned above such as the speech data or keystroke data) is available. Of course, when only one user input form is available, then the integrator 19 will not be required.

In the above-described examples, objects on a graphical user interface are identified by the user specifying a name describing the object or its colour or an x, y coordinate location. Other ways of specifying or identifying an object may be possible, for example the user may specify the object's relation to another object (for example a user may identify an object by specifying it as the biggest or smallest displayed object, the object in the top corner of the screen and so on), indeed the user may use any way of identifying an object that the data provider can identify.

The restrictions on the available objects and colours that the user may specify may be different from those mentioned above and generally will depend upon the particular application that the data processor implements. Thus, the data model may specify different or additional object names and colour names to those mentioned above. Where colour is concerned this may also include or be replaced by pattern names such as striped, spotted, checkerboard and so on, different types of colour fill such as fountain fill and so on and colour combinations. Also, depending upon the particular data processor, the colour data entry location and the changecolour action may be omitted.

It will of course be appreciated that the examples described above are only illustrative examples and that the present invention may be applied where the attributes that the user can control and the actions that the user can instruct the data processor to carry out are different from those specified above. For example, the present invention may be applied in systems where the objects have completely different attributes to those above, for example where the user can instruct the processor to carry out actions on attributes such as flight numbers, flight departure times, flight arrival times, and many other different attributes. The present invention is particularly useful in multi-modal applications.

In the above-described embodiments, the user interface provides a graphical user interface. Other forms of user interface may be used, for example the user interface may be at least partially or entirely a spoken user interface.

In the above embodiments the schema, data model and data model extension are implemented using XML (extensible Mark up Language), Xforms and Xpath with the data model extension 18 being provided by extending the XForms model bind property definition to allow application method calls within the calculate property of the Xforms model item. It is however possible that the present invention may be applied to other mark up languages and schemes.

In the above described examples, the user input interpreter, user interface and data processor are provided by programming the same computing apparatus. As another possibility, the user input interpreter, user interface and data processor may be provided by programming separate computing apparatus that communicate via a communications link such as a network, LAN, WAN, the Internet or an intranet. As another possibility, the user input interpreter and user interface may be provided separately from the data processor and may communicate with the data processor via such a communications link.

1. A user input interpreter comprising:
a receiver operable to receive user input data specifying an object and an operation to be carried out on the object;
an associater operable to associate received user input data with semantic identifiers in accordance with semantic rules; and
a populater operatable to populate data entry locations of a data model in accordance with semantically identified user input data associated with the semantic identifiers specified for those data entry locations, wherein
the data model has data model extension data identifying at least one process that has to be carried out by a data processor to identify an object specified by the user; and
the populater is arranged to communicate with the data processor to instruct the data processor to carry out a process identified by the extension data and to return object identifier data that identifies to the data processor the object specified by the user.

2. A user input interpreter according to claim 1, wherein the populater is arranged to communicate with the data processor to instruct the data processor to carry out a process identified by the extension data and to return object identifier data that identifies to the data processor when data entry locations of the data model have been populated in accordance with user input data specifying an object and an operation to be carried out on that object.

3. A user input interpreter according to claim 1, wherein the receiver comprises a plurality of different user input mode receivers.

4. A user input interpreter according to claim 3, wherein the associater comprises a respective semantic meaning associater for each input mode and an integrater is provided to integrate semantically identified user input data from the different semantic meaning associaters.

5. A user input interpreter according to claim 4, wherein the integrater is arranged to integrate semantically identified user input data from the different semantic meaning associaters when the different mode user input receivers receive user input simultaneously or within a predetermined time of one another.

6. A user input interpreter according to claim 5, wherein the integrater is arranged to consider semantically identified user input data from the different semantic meaning associaters to be integrated to be of different semantic data types.

7. A user input interpreter according to claim 1, adapted for use with a data processor having a graphical user interface to enable a user to provide a data processor with a user command to control an operation to be carried out on an object displayed on the graphical user interface of the data processor.

8. A user input interpreter according to claim 3, adapted for use with a data processor having a graphical user interface to enable a user to provide a data processor with a user command to control an operation to be carried out on an object displayed on the graphical user interface of the data processor, wherein the plurality of different user input mode receivers comprises a position data input mode receivers and a text data input mode receiver.

9. A user input interpreter according to claim 8, wherein the data model has an object position data entry location associated with a semantic identifier specifier specifying a semantic identifier representing position and an object identity data entry location associated with a semantic identifier specifier specifying a semantic identifier representing an object identity.

10. A user input interpreter according to claim 1, comprising a data model constrainer operable to constrain the user input available for the user command.

11. A user input interpreter according to claim 3, comprising a data model constrainer operable to constrain the user input available for the user command.

12. A user input interpreter according to claim 9, comprising a data model constrainer operable to constrain the user input available for the user command and wherein the data model constrainer is arranged to allow population of either the object position data entry location or the object identity data entry location.

13. A user input interpreter according to claim 3, wherein the data model also allows a user to specify an object colour.

14. A user input interpreter according to claim 13, wherein the data model has a colour position data entry location associated with a semantic identifier specifier specifying a semantic identifier representing position and a colour identity data entry location associated with semantic identifier specifier specifying a semantic identifier representing a colour identity.

15. A user input interpreter according to claim 3, wherein the data model also allows a user to specify an object colour, the data model has a colour position data entry location associated with a semantic identifier specifier specifying a semantic identifier representing position and a colour identity data entry location associated with a semantic identifier specifier specifying a semantic identifier representing a colour identity and the interpreter comprises a data model constrainer operable to constrain the user input available for the user command and the data model constrainer is arranged to allow the population of either the colour position data entry location or colour identity data entry location.

16. A user input interpreter according to claim 10, wherein the data constrainer is arranged to constrain the objects to a set of specified objects.

17. A user input interpreter according to claim 16, wherein the data model constrainer is arranged to constrain the set of specified objects to comprise rectangle, triangle and circle.

18. A user input interpreter according to claim 10, wherein the data model constrainer is arranged to constrain the operations to a set of specified operations.

19. A user input interpreter according to claim 18, wherein the data model constrainer is arranged to constrain the set of specified operations to comprise: move, copy, delete, resize.

20. A user input interpreter according to claim 13, wherein the data model constrainer is arranged to constrain the operations to a set of specified operations comprising: move, copy, delete, resize and change colour.

21. A user input interpreter according claim 1, wherein a requirement determiner is provided to require user input associated with a specific semantic identifier for an operation.

22. A user input interpreter according to claim 19, wherein a requirement determiner is provided to require user input associated with a specific semantic identifier for an operation and is arranged to require user input associated with a semantic identifier representing position when the operation is move or copy.

23. A user input interpreter according to claim 19, wherein a requirement determiner is provided to require user input associated with a specific semantic identifier for an operation and is arranged to require user input associated with a semantic identifier representing scale when the operation is resize.

24. A user input interpreter according to claim 19, wherein a requirement determiner is provided to require user input associated with a specific semantic identifier for an operation and is arranged to require user input associated with a semantic identifier representing colour when the operation is change colour.

25. A user input interpreter according to claim 1, wherein the data model is provided as an XForms data model and the data model extension data is provided as an extension of the XForms model bind property to allow process or method calls within the calculate property of the XForms model item.

26. A user input interpreter according to claim 25, further comprising a data model constrainer operable to constrain the user input available for the user command, wherein the data model constrainer comprises an XML schema.

27. A user input interpreter according to claim 25, further comprising a requirement determiner operable to require user input associated with a specific semantic identifier for an operation, wherein the requirement determiner is provided as binding references of the XForms data model.

28. A data processing apparatus comprising a data processor and a user input interpreter in accordance with claim 1, wherein the data processor comprises a word processor, an image processor, a command processor operable to control operation of a computer controlled machine or tool or other data processor that may be implemented by programming computer apparatus with a software application.

29. A data processing apparatus according to claim 28, further comprising user interface devices comprising at least one of a keyboard, a microphone, a writing tablet, a pointing device.

30. A data model provider for a user input interpreter for interpreting user input to enable a user to provide a data processor with a user command for controlling an operation to be carried out on an object presented to the user by a user interface of the data processor, the data model provider comprising:
a data model structure provider providing a data model structure providing data entry location elements for enabling a data model developer to specify object and operation data entry locations to be populated in accordance with user input data to enable a user command to be generated to cause the data processor to carry out an operation on an object, each data entry location element specifying the semantic identifier required to be associated with received user input data for that data entry location to be populated and a data model extension structure enabling the data model developer to specify extension data identifying at least one process that has to be carried out by the data processor to identify an object specified by the user.

31. A data model provider according to claim 30, wherein the data model structure also provides a data entry element for a data model developer to specify a colour data entry location.

32. A data model provider according to claim 30, wherein the data model structure has a data model constraining structure configured to constrain the user input available for particular data entry elements.

33. A data model provider according to claim 32, wherein the data model constraining structure is configured to constrain an object or a colour to be specified by user input representing an identity or position of the colour or the object.

34. A data model provider according to claim 32, wherein the data model constraining structure is configured to constrain a data entry location to at least one of:
only certain options;
certain named where the data entry location requires data having a semantic identifier representing objects;
certain colours where the data entry location requires data having a semantic identifier representing colours; and
certain actions where the data entry location requires data having a semantic identifier representing actions.

35. A data model provider according to claim 30, wherein the data model structure provider has a requirement determining structure arranged to require user input associated with a specific semantic identifier for an operation.

36. A data model provider according to claim 35, wherein the requirement determining structure is arranged to at least one of:
require user input associated with a semantic identifier representing position when the operation is move or copy;
require user input associated with a semantic identifier representing scale when the operation is resize; and
require user input associated with a semantic identifier representing colour when the operation is change colour.

37. A data model provider according to claim 30, wherein the data model structure provider is arranged to provide an XForms data model structure and the data model extension structure is provided as an extension of the XForms model bind property to allow process or method calls within the calculate property of the XForms model item.

38. A data model provider according to claim 37, wherein the data model structure has a data model constraining structure configured to constrain the user input available for particular data entry elements, and wherein the data model constraining structure is provided by an XML schema structure.

39. A data model provider according to claim 38, wherein the data model structure provider has a requirement determining structure arranged to require user input associated with a specific semantic identifier for an operation, and wherein the requirement determining structure is configured to provide requirements as binding references of the XForms data model.

40. A user input interpreter apparatus for providing a user input interpreter for interpreting user input to enable a user to provide a data processor with a user command to control an operation to be carried out on an object presented to the user by a user interface of the data processor, the user input interpreter apparatus comprising:
a semantic rule store arranged to store semantic rules associating different possible user input data with semantic identifiers identifying the semantic data type of that possible user input data;
a data model provider in accordance with claim 30;
a semantic meaning associater operable to associate received user input data with semantic identifiers in accordance with semantic rules stored in the semantic rules store to provide semantically identified user input data; and
a data model populater operable to populate data entry locations of a data model provided by the data model provider in accordance with semantically identified user input data associated with the semantic identifiers specified for those data entry locations, the data model populater being arranged to communicate with the data processor to instruct the data processor to carry out a process identified by the extension data and to return object identifier data that identifies to the data processor the object specified by the user and the data model populater being arranged to complete population of the data model to generate the user command upon receipt of the object identifier data.

41. A method of interpreting user input, the method comprising the steps of:
accessing a data model having object and operation data entry locations;
receiving user input data specifying an object presented to the user by the user interface and an operation to be carried out on the object;
associating received user input data with semantic identifiers in accordance with semantic rules; and
populating data entry locations of the data model in accordance with semantically identified user input data associated with the semantic identifiers specified for those data entry locations;
wherein the data model has data model extension data identifying at least one process that has to be carried out by a data processor to identify an object specified by the user; and
wherein the populating step comprises the step of communicating with the data processor to instruct the data processor to carry out a process identified by the extension data and to return object identifier data that identifies the object specified by the user.

42. A method of providing a data model for a user input interpreter for interpreting user input to enable a user to provide a data processor with a user command for controlling an operation to be carried out on an object presented to the user by a user interface of the data processor, the method comprising the step of providing a data model structure that includes data entry location elements for enabling a data model developer to specify object and operation data entry locations to be populated in accordance with user input data to enable a user command to be generated for causing the data processor to carry out an operation on an object, each of the data entry location elements specifying the semantic identifier required to be associated with received user input data for that data entry location to be populated and a data model extension structure enabling the data model developer to specify extension data identifying at least one process that has to be carried out by the data processor to identify an object specified by the user.

43. A method according to claim 42, wherein the data model structure includes a data entry element for a data model developer to specify a colour data entry location.

44. A method according to claim 42, wherein the data model structure has a data model constraining structure constraining the user input available for particular data entry elements.

45. A method according to claim 44, wherein the data model constraining structure constrains at least one of:
an object or a colour to be specified by user input representing an identity or position of the colour or the object;
a data entry location to only certain options;
a data entry location to certain named objects where the data entry location requires data having a semantic identifier representing objects; a data entry location to certain colours where the data entry location requires data having a semantic identifier representing colours; and
a data entry location to certain actions where the data entry location requires data having a semantic identifier representing actions.

46. A method according to claim 42, wherein the data model structure has requirements requiring user input associated with a specific semantic identifier for an operation.

47. A method according to claim 46, wherein the data model structure requirements require user input associated with a semantic identifier representing position when the operation is move or copy, require user input associated with a semantic identifier representing scale when the operation is resize, and require user input associated with a semantic identifier representing colour when the operation is change colour.

48. A method according to claim 42, wherein the data model structure is an XForms data model structure and the data model extension structure is provided as an extension of the XForms model bind property to allow process or method calls within the calculate property of the XForms model item.

49. A method according to claim 48, wherein the data model structure has a data model constraining structure constraining the user input available for particular data entry elements, and wherein the data model constraints are provided by an XML schema structure.

50. A method according to claim 49, wherein the data model structure requires user input associated with a specific semantic identifier for an operation, and wherein the requirements are provided as binding references of the XForms data model.

51. Program instructions for programming a processor to carry out a method in accordance with claim 41.

52. Program instructions for programming a processor to provide a user input interpreter in accordance with claim 1.

53. An instruction signal comprising program instructions in accordance with claim 52.

54. A computer-readable storage medium storing program instructions in accordance with claim 52.

55. Program instructions for programming a processor to provide a data model provider in accordance with claim 30.

56. Program instructions for programming a processor to provide a user input interpreter apparatus in accordance with claim 40.

57. A user input interpreter comprising:
receiving means for receiving user input data specifying an object and an operation to be carried out on the object;
associating means for associating received user input data with semantic identifiers in accordance with semantic rules; and
populating means for populating data entry locations of a data model in accordance with semantically identified user input data associated with the semantic identifiers specified for those data entry locations, wherein
the data model has data model extension data identifying at least one process that has to be carried out by a data processor to identify an object specified by the user; and
the populating means is arranged to communicate with the data processor to instruct the data processor to carry out a process identified by the extension data and to return object identifier data that identifies to the data processor the object specified by the user.
